(19) United States
(12) Patent Application Publication
(10) Pub. No.: US 2022/0224169 A1
(43) Pub. Date: Jul. 14, 2022

(54) POWER TRANSMISSION DEVICE, POWER RECEPTION DEVICE, AND POWER TRANSMISSION/RECEPTION SYSTEM INCLUDING THE SAME

(71) Applicant: Hitachi-LG Data Storage, Inc., Tokyo (JP)

(72) Inventor: Kozo MASUDA, Tokyo (JP)

(21) Appl. No.: 17/510,695

(22) Filed: Oct. 26, 2021

(30) Foreign Application Priority Data
Jan. 12, 2021 (JP) 2021-002591

(51) Int. Cl. H02J 50/90; H02J 50/00; H02J 50/10; H02J 50/80; H02J 7/00; H02J 7/04

(52) U.S. Cl. CPC H02J 50/90; H02J 50/005; H02J 50/10; H02J 7/00034; H02J 7/0045; H02J 7/04; H02J 50/80

(57) ABSTRACT

A power transmission device that has a power transmission coil and transmits power to a power reception device having a power reception coil by wireless power transmission, includes positioning means for placing the power reception device, the power transmission coil being disposed to be substantially parallel to a lower part of a placement surface of the positioning means, in which when the power reception device is placed on the placement surface of the positioning means, the power reception coil is disposed to be substantially parallel to the placement surface and is disposed by sliding a center of the power transmission coil by a predetermined distance from a center of the power reception coil.

### CROSS-REFERENCE TO RELATED APPLICATION

The present application claims priority from Japanese application JP2021-002591, filed on Jan. 12, 2021, the contents of which is hereby incorporated by reference into this application.

### BACKGROUND OF THE INVENTION

### 1. Field of the Invention

The present invention relates to a technology for wireless power transmission.

### 2. Description of the Related Art

For example, in a small portable electronic device such as a mobile terminal or a game machine, a secondary battery built in the device is generally charged from an AC outlet or an auxiliary power supply by wire via a charging terminal. However, in recent years, with the widespread use of electronic devices, an increasing number of models use a wireless power transmission method performed without contact without interposing the charging terminal as a simple charging method in consideration of usability.

With regard to a wireless power transmission device in the present technical field, for example, there is one described in JP 2013-179820 A. In JP 2013-179820 A, in electromagnetic induction wireless power transmission, in order to improve power transmission efficiency from a power transmission coil to a power reception coil, it is necessary to accurately align a position of the power reception coil with respect to the power transmission coil, and a configuration for detecting relative positions of the power transmission coil and the power reception coil with a simple configuration is disclosed.

In JP 2013-179820 A, central axes of the power transmission coil and the power reception coil are aligned with each other based on the detected relative positions of the power transmission coil and the power reception coil.

However, there is a phenomenon that when a distance between the power transmission coil and the power reception coil becomes short due to thinning of the power transmission device and the electronic device that receives power, a coupling coefficient of the both coils becomes excessively high and transmissible power decreases. Therefore, the relative positions of the power transmission coil and the power reception coil prioritizing power transmission efficiency may not match a position where maximum power is obtained. Therefore, in JP 2013-179820 A, only the power transmission efficiency is considered, and the transmissible power is not considered.

### SUMMARY OF THE INVENTION

In view of the above-mentioned problem, an object of the invention is to provide a power transmission device and a power reception device capable of adjusting relative positions between a power transmission coil and a power reception coil allowing maximization of transmissible power, and a power transmission/reception system including the same.

An example of the invention is a power transmission device that has a power transmission coil and transmits power to a power reception device having a power reception coil by wireless power transmission, including positioning means for placing the power reception device, the power transmission coil being disposed to be substantially parallel to a lower part of a placement surface of the positioning means, in which when the power reception device is placed on the placement surface of the positioning means, the power reception coil is disposed to be substantially parallel to the placement surface and is disposed by sliding a center of the power transmission coil by a predetermined distance from a center of the power reception coil.

According to the invention, it is possible to provide a power transmission device and a power reception device capable of adjusting relative positions between a power transmission coil and a power reception coil allowing maximization of transmissible power, and a power transmission/reception system including the same.

### BRIEF DESCRIPTION OF THE DRAWINGS

FIG. 1 is a schematic configuration block diagram of a power transmission/reception system in a first embodiment;

FIG. 2 is a schematic functional configuration diagram of a power reception device main function part in the first embodiment;

FIG. 3 is a plan view and a side view of a power transmission device in the first embodiment;

FIG. 4 is a plan view and a side view of a power reception device in the first embodiment;

FIG. 5 is a plan view and side views of a state in which the power reception device in the first embodiment is placed on the power transmission device;

FIGS. 6A and 6B are a plan view and a side view of a modification of the power transmission device in the first embodiment;

FIGS. 7A to 7C are plan views of another modification of the power transmission device in the first embodiment;

FIGS. 8A to 8C are explanatory diagrams of a method for determining a relative distance between the power transmission coil and the power reception coil allowing maximization of transmissible power in the first embodiment;

FIG. 9 is a processing flow diagram for determining a relative distance between the power transmission coil and the power reception coil allowing maximization of transmissible power in the first embodiment;

FIG. 10 is a schematic configuration block diagram of a power transmission/reception system in a second embodiment;

FIGS. 11A and 11B are plan views and side views of a state in which a power reception device is placed on a power transmission device in the second embodiment;

FIGS. 12A to 12C are diagrams for description of an example of a display screen in the power reception device in the second embodiment;

FIGS. 13A and 13B are plan views and side views of a power transmission device in a third embodiment;

FIG. 14 is a schematic configuration block diagram of a power transmission/reception system in a fourth embodiment;

FIG. 15 is a processing flow diagram of wireless power transmission using data transmission in the fourth embodiment;

FIGS. 16A to 16C are diagrams for description of an example of a display screen in a power reception device in the fourth embodiment; and

FIGS. 17A to 17C are diagrams for description of a problem of conventional wireless power transmission.

### DETAILED DESCRIPTION OF THE PREFERRED EMBODIMENTS

Hereinafter, embodiments of the invention will be described with reference to the drawings.

### First Embodiment

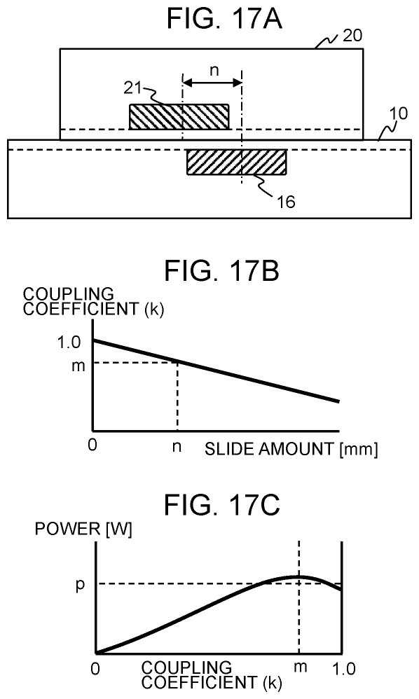

First, a problem of conventional wireless power transmission will be described. FIGS. 17A to 17C are diagrams for description of the problem of the conventional wireless power transmission. FIG. 17A is a schematic cross-sectional view of a state in which a power reception device 20 is placed on a power transmission device 10 as viewed from a side. A power transmission coil 16 and a power reception coil 21 are disposed to be substantially parallel to a placement surface, and disposed so as to be separated from each other by a distance of thicknesses of respective housings.

When the power reception device 20 is charged, a back surface (lower surface) of the housing of the power reception device 20 is placed on the power transmission device 10 so as to face an upper surface of the housing of the power transmission device 10, and a power transmission switch of the power transmission device 10 is turned ON. Then, an AC magnetic flux is generated by a high-frequency current flowing through the power transmission coil 16, an AC voltage is induced in the facing power reception coil 21 by an electromagnetic dielectric action similar to a principle of a transformer, and power is supplied to a secondary battery of the power reception device 20, so that the power reception device 2 can be charged to 0.

Here, as illustrated in FIG. 17B, in a relationship between a slide amount, which is a difference between central axes of the power transmission coil 16 and the power reception coil 21, and a coupling coefficient, the coupling coefficient becomes a maximum when the slide amount is zero. Thus, in the conventional wireless power transmission, in order to ensure the power transmission efficiency at the time of power transmission, the central axes of the power transmission coil and the power reception coil 21 are aligned. That is, alignment is performed so that the difference n between the central axes of the power transmission coil 16 and the power reception coil 21 illustrated in FIG. 17A is set to zero.

However, as illustrated in FIG. 17C, there is a phenomenon that when the distance between the power transmission coil and the power reception coil becomes short due to thinning of the power transmission device and the electronic device that receives power, the coupling coefficient of the both coils becomes excessively high, so that the mutual inductance increases, and transmissible power decreases. That is, relative positions of the power transmission coil and the power reception coil prioritizing power transmission efficiency may not match a position where maximum power is obtained.

Therefore, the present embodiment provides a power transmission device and a power reception device capable of adjusting relative positions of a power transmission coil and a power reception coil allowing maximization of transmissible power, and a power transmission/reception system including the same. Hereinafter, a specific description will be given.

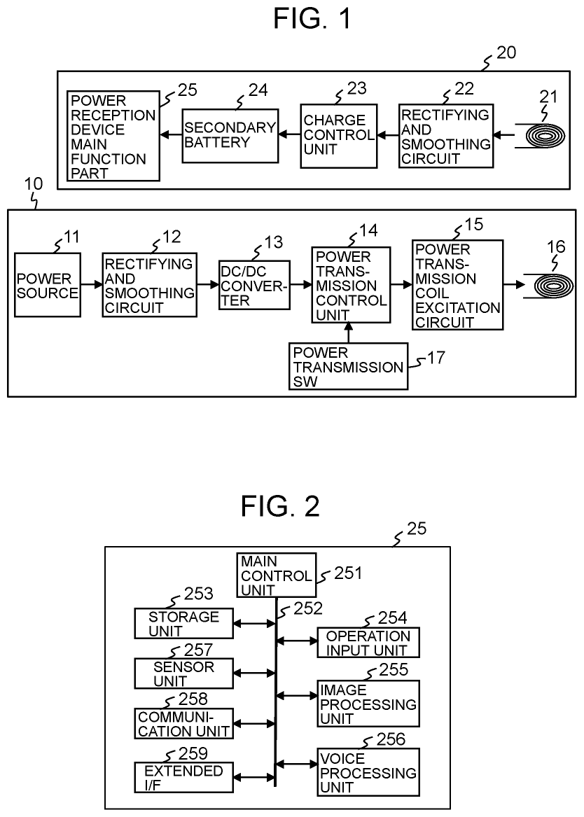

FIG. 1 is a schematic configuration block diagram of a power transmission/reception system in the present embodiment. In FIG. 1, the power transmission/reception system includes a power transmission device 10 having a power transmission coil 16 that wirelessly transmits power (high-frequency current), and a power reception device 20 having a power reception coil 21 that receives power transmitted from the power transmission device 10.

The power transmission device 10 may be a stationary charging stand that uses a general-purpose power supply of AC 100 to 120 V, or may be a fixedly used form placed on a desk or a table or embedded in a recess on an upper surface of the furniture.

In FIG. 1, the power transmission device 10 includes a power transmission coil 16, a power transmission switch (power transmission SW) 17, a power source 11, a rectifying and smoothing circuit 12, a DC/DC converter 13, a power transmission control unit 14, and a power transmission coil excitation circuit 15.

The power source 11 has, for example, a power cable for inputting an AC voltage (AC 100 V) from a power outlet, a switch IC for switching power supply ON/OFF, etc., and supplies an AC voltage transmitted through the power cable to the rectifying and smoothing circuit 12.

The rectifying and smoothing circuit 12 is, for example, a circuit using a semiconductor diode and a capacitor, and converts an input AC voltage into a constant DC voltage by performing rectification (DC conversion) and smoothing processing of the AC voltage, and supplies the power after conversion to the DC/DC converter 13.

The DC/DC converter 13 converts (steps down) the input DC voltage into a voltage required for exciting the power transmission coil 16 and supplies the power after stepping down to the power transmission control unit 14.

The power transmission control unit 14 supplies or stops supply of the DC voltage input from the DC/DC converter 13 to the power transmission coil excitation circuit 15 according to a state (ON or OFF) of the power transmission SW 17. Note that the power transmission control unit 14 is a processor such as a CPU or MPU, and controls the entire power transmission device 10 by software processing in which the processor executes a basic program stored in a storage device.

The power transmission coil excitation circuit 15 includes an inverter circuit that converts a DC voltage into an AC voltage in order to excite the power transmission coil 16. Further, the power transmission coil excitation circuit 15 converts the DC voltage supplied from the power transmission control unit 14 into an AC voltage having a predetermined voltage and frequency, and outputs the AC voltage to the power transmission coil 16.

The power transmission coil 16 is a spiral type circular coil in which an electric wire such as a litz wire is wound so as to form a substantially ring shape in a plane.

Next, the power reception device 20 is, for example, a portable terminal device such as a smartphone, and the power reception coil 21 forming a power reception unit is disposed in the housing. In FIG. 1, the power reception device 20 includes the power reception coil 21, a rectifying and smoothing circuit 22, a charge control unit 23, and a secondary battery 24 as the power reception unit, and has a power reception device main function part 25. For example, when the power reception device 20 is a smartphone, a touch panel type operation input unit having both an operation input function and an image display function, an image processing unit, a voice processing unit, a sensor unit, a communication unit, etc. are the main function part. Details will be described later.

In FIG. 1, the power reception coil 21 is a spiral type circular coil having the same configuration as that of the power transmission coil 16 described above. The rectifying and smoothing circuit 22 is, for example, a circuit including a diode and a capacitor, and rectifies (pulsates) and smoothes an induced current (alternating current) generated in the power reception coil 21 to generate a DC voltage having a stable voltage. The charge control unit 23 supplies the DC voltage input from the rectifying and smoothing circuit 22 to the secondary battery 24. The secondary battery 24 is a battery that can be repeatedly charged and discharged, and is, for example, a lithium ion battery.

FIG. 2 is a schematic functional configuration diagram of a power reception device main function part when the power reception device 20 is a smartphone. As illustrated in FIG. 2, the power reception device main function part 25 includes a main control unit 251, a storage unit 253, an operation input unit 254, an image processing unit 255, a voice processing unit 256, a sensor unit 257, a communication unit 258, an extended interface (I/F) 259, etc., which are electrically connected via a system bus 252.

The main control unit 251 is a processor such as a CPU or MPU, and controls all the functional units of the power reception device main function part 25 by software processing in which the processor executes a basic program stored in the storage unit 253. Note that the main control unit 251 may also function as the charge control unit 23 and control not only the power reception device main function part 25 but also the entire power reception device 20 including the power reception unit.

Note that each function of the power reception device main function part 25 of FIG. 2 is similar to a function of a generally known smartphone, and details thereof will be omitted and brief description will be given below.

The operation input unit 254 is a user operation interface that receives an operation input of a user to the power reception device 20. Specifically, the operation input unit 220 includes operation keys such as a power key, a volume key, and a home key, a touch panel, etc. The touch panel is a touch screen integrally disposed on top of the display unit.

The image processing unit 255 includes a display unit, an image signal processing unit, and an image pickup unit, generates an electric signal captured by the image pickup unit as digital image data, and displays the generated image data. Further, the image data read from the storage unit 253 is displayed on the display unit.

The voice processing unit 256 includes a voice output unit, a voice signal processing unit, and a voice input unit, outputs voice processed by the voice signal processing unit, and inputs voice of the user, etc. from the voice input unit.

The sensor unit 257 includes an acceleration sensor that detects movement, vibration, impact, etc., a gyro sensor that detects the angular velocity in a rotation direction and captures a state of vertical, horizontal, and diagonal postures, etc.

The communication unit 258 is connected to a network by a wireless communication method to transmit and receive data to and from a management server on the network, and performs short-range wireless communication, etc.

The extended I/F 259 is a group of interfaces for detecting a function of the power reception device 20.

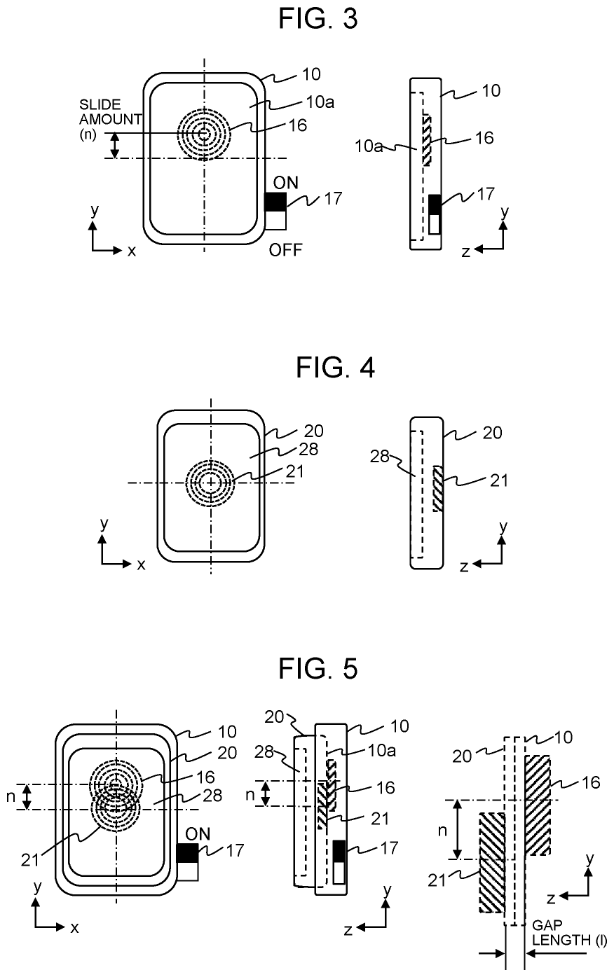

FIG. 3 is a plan view and a side view of the power transmission device 10 in the present embodiment. In FIG. 3, the left side is the plan view, and the right side is the side view. In FIG. 3, the power transmission device 10 has a recess 10a having a flat placement surface on which the power reception device 20 is placed, and the recess 10a matches an outer shape of the power reception device 20 and functions as a positioning for fixing a position of the power reception device 20 to be placed. In addition, the power transmission coil 16 is disposed to be substantially parallel to a lower part of the placement surface of the recess 10a, and is disposed by sliding a center of the power transmission coil 16 from a center of the housing of the power transmission device 10 by n in a y-axis direction. Further, the power transmission SW 17 is a slide-type manual switch and is disposed on a side surface of the housing of the power transmission device 10. Note that the power transmission SW 17 may be, for example, any other type of switch, such as a push-type switch.

FIG. 4 is a plan view and a side view of the power reception device 20 in the present embodiment. In FIG. 4, the left side is the plan view in which a surface of a display panel 28 is an x-y plane in an image of a smartphone, and the right side is a side view seen in a positive direction of an x-axis. The power reception coil 21 is disposed to be substantially parallel to the lower surface of the housing in a lower part of the display panel 28, and a center of the power reception coil 21 is disposed at a center of the power reception device 20.

FIG. 5 is a plan view and side views of a state in which the power reception device 20 illustrated in FIG. 4 in the present embodiment is placed on the power transmission device 10 illustrated in FIG. 3. In FIG. 5, the left side is the plan view, the center is the side view, and the right side is an enlarged view of the center which is the side view. As illustrated in FIG. 5, the power reception device 20 is housed in the recess 10a of the power transmission device 10, and a position of the power reception device 20 placed on the power transmission device 10 is fixed. That is, a center of the power transmission coil 16 and a center of the power reception coil 21 are disposed by sliding by n in the y-axis direction. Note that in FIG. 5, in an x-direction, each coil is at the center of the housing, and it is sufficient that centers of the two coils are separated by n. Thus, for example, the two coils may be disposed by being shifted in the x-direction, a y-direction, or both directions while maintaining the distance. In addition, as illustrated in the right side of FIG. 5, the power transmission coil 16 and the power reception coil 21 are disposed with a gap length 1, which is a distance of the thicknesses of the respective housings, via the placement surface of the recess 10a.

For this reason, when the slide amount n from the center of the power transmission coil 16 in the power transmission device 10 is designed to be a relative distance between the power transmission coil and the power reception coil allowing maximization of transmissible power, it is possible to provide a power transmission device and a power reception device allowing maximization of transmissible power, and a power transmission/reception system including the same.

Note that in description of FIG. 3 to FIG. 5, the slide amount n is ensured on the power transmission device 10 side. However, since it is sufficient that the relative distance between the power transmission coil and the power reception coil is the slide amount n, the center of the power reception coil 21 on the power reception device 20 side may be slide by n in the y-axis direction from the center of the housing of the power reception device 20, and the slide amount on the power transmission device 10 side may be zero. Further, the slide amount n may be shared between the power transmission device 10 and the power reception device 20.

In addition, it has been described that the recess 10a of the power transmission device 10 matches the outer shape of the power reception device 20 and functions as a positioning for fixing the position of the power reception device 20 to be placed. However, since it is sufficient that the recess 10a functions as a positioning for fixing the position of the power reception device 20, the recess 10a does not have to match the outer shape of the power reception device 20. For example, a protrusion for fixing the position of the power reception device 20 may be provided.

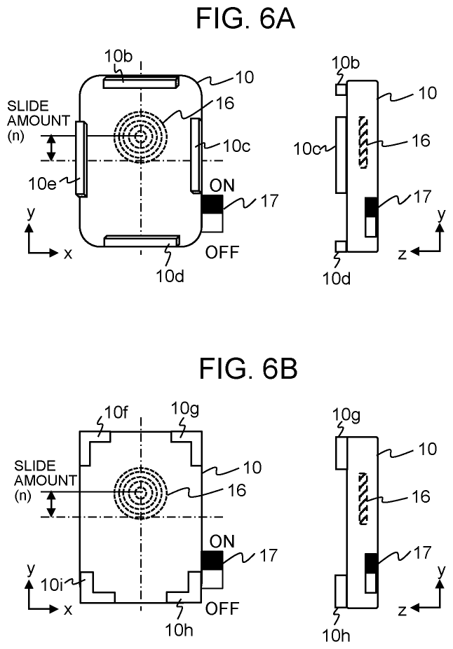

FIGS. 6A and 6B are a modification of FIG. 3 and a plan view and a side view of the power transmission device in the present embodiment. In FIGS. 6A and 6B, the same configurations as those in FIG. 3 are designated by the same reference symbols, and a description thereof will be omitted. In FIGS. 6A and 6B, a difference from FIG. 3 is that positioning means, which is a protrusion for positioning, is provided instead of the recess 10a on which the power reception device 20 is placed. That is, FIG. 6A has positioning means 10b, 10c, 10d, and 10e at four sides of an outer shape of the power transmission device 10, and when the power reception device 20 is placed, positions of the power transmission device 10 and the power reception device 20 can be fixed. Further, FIG. 6B has L-shaped positioning means 10f, 10g, 10h, and 10i at four corners of the outer shape of the power transmission device 10, and when the power reception device 20 is placed, the positions of the power transmission device 10 and the power reception device 20 can be fixed. In this way, similarly to FIG. 5, the positions of the power transmission coil 16 in the power transmission device 10 and the power reception coil 21 in the power reception device 20 can be specified. Thus, when the slide amount n, which is the relative distance between the power transmission coil and the power reception coil, is set to be a relative distance between the power transmission coil and the power reception coil allowing maximization of transmissible power, it is possible to provide a power transmission device and a power reception device allowing maximization of transmissible power, and a power transmission/reception system including the same.

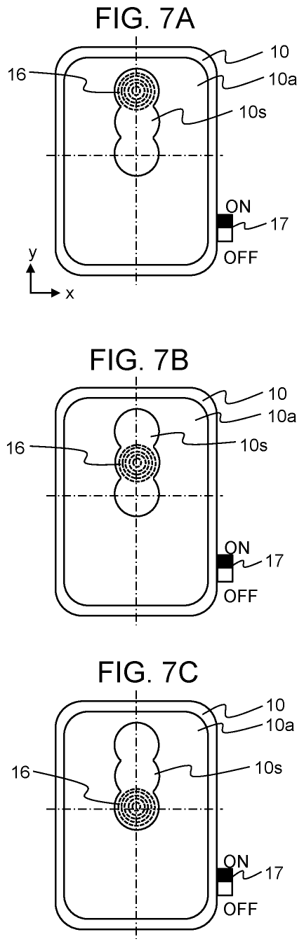

FIGS. 7A to 7C are another modification of FIG. 3 and are plan views of the power transmission device in the present embodiment. In FIGS. 7A to 7C, the same configurations as those in FIG. 3 are designated by the same reference symbols, and a description thereof will be omitted. In FIGS. 7A to 7C, a difference from FIG. 3 is that a power transmission coil storage space 10s having a plurality of positions where the power transmission coil 16 can be installed is disposed so as to be substantially parallel to the lower part of the placement surface of the recess 10a, and the power transmission coil 16 is fixed at a desired power transmission coil position depending on where the power transmission coil 16 is placed in the power transmission coil storage space 10s. That is, FIG. 7A illustrates a case where the power transmission coil storage space 10s having three positions where the power transmission coil 16 can be installed is provided, and the power transmission coil 16 is disposed at a position farthest from the center of the housing of the power transmission device 10 in the y-axis direction. FIG. 7B illustrates a case where the power transmission coil 16 is disposed at a position separated by an intermediate distance in the y-axis direction from the center of the housing of the power transmission device 10. Further, FIG. 7C illustrates a case where the center of the power transmission coil 16 is disposed at a position of the center of the housing of the power transmission device 10.

In this way, while the number of cases of the slide amount n is fixed to one in FIG. 3, the position of the power transmission coil 16 can be selected from a plurality of positions in FIGS. 7A to 7C. For this reason, when a space for housing a plurality of power transmission coils 16 is designed so that the slide amount n from the center of the power transmission coil 16 in the power transmission device 10 can be selected, and the slide amount n is selected at the time of manufacture to have a position for obtaining the relative distance between the power transmission coil and the power reception coil allowing maximization of transmissible power, it is possible to provide a power transmission device and a power reception device allowing maximization of transmissible power, and a power transmission/reception system including the same.

Note that in description of FIGS. 7A to 7C, the slide amount n is ensured on the power transmission device 10 side. However, the position of the power reception coil 21 may be selected from a plurality of positions on the power reception device 20 side. Further, the slide amount n may be shared between the power transmission device 10 and the power reception device 20.

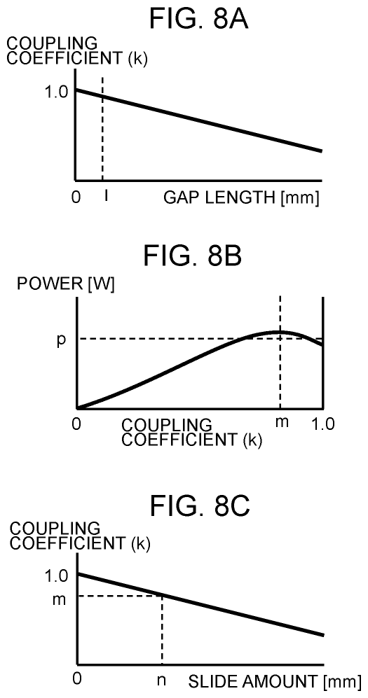

FIGS. 8A to 8C are explanatory diagrams of a method for determining a relative distance between the power transmission coil and the power reception coil allowing maximization of transmissible power in the present embodiment. FIG. 8A is a diagram illustrating a relationship between a gap length and a coupling coefficient at a predetermined slide amount of the power transmission coil and the power reception coil, and the coupling coefficient decreases as the gap length increases at the predetermined slide amount. In addition, FIG. 8B is a diagram illustrating a relationship between the coupling coefficient and transmissible power, and a coupling coefficient m in a central portion in a range in which target power p can be obtained is obtained by adjusting the gap length in a state of a predetermined slide amount (for example, slide amount=0). Note that the coupling coefficient m does not have to be in the central portion as long as the coupling coefficient m is in a range in which desired power can be obtained. Next, FIG. 8C is a diagram illustrating a relationship between the slide amount of the power transmission coil and the power receiving coil and the coupling coefficient, and the slide amount n at which the coupling coefficient becomes m is obtained by changing the slide amount under a condition of a desired gap length.

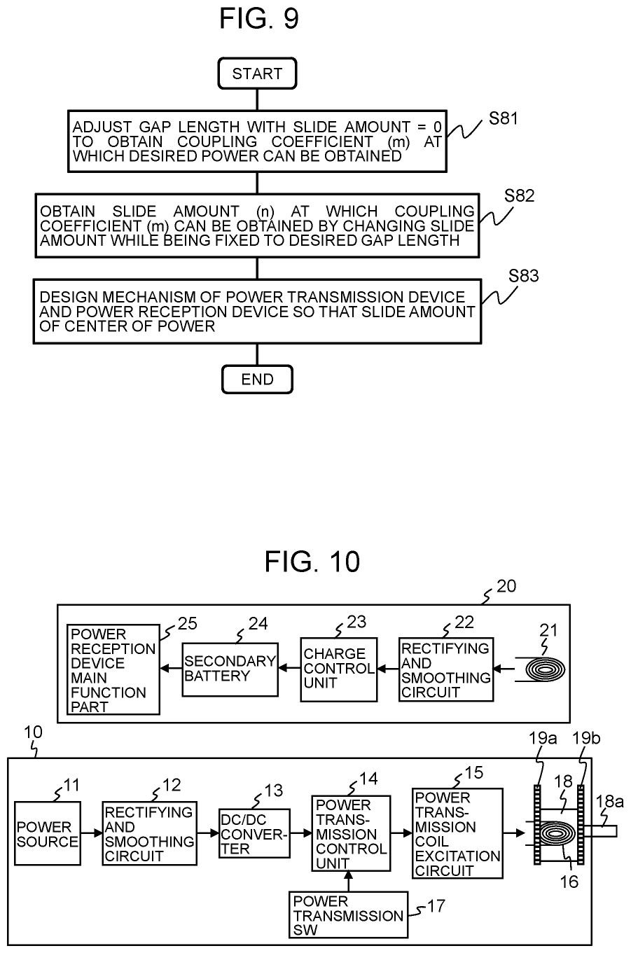

FIG. 9 is a processing flow diagram for determining a relative distance between the power transmission coil and the power reception coil allowing maximization of transmissible power in the present embodiment. In FIG. 9, according to the method for determining the relative distance between the power transmission coil and the power reception coil allowing maximization of transmissible power described in FIGS. 8A to 8C, a coil position of the power transmission device 10 or the power reception device 20 is executed at a design stage so that the relative distance between the power transmission coil and the power reception coil becomes the obtained slide amount n. Specifically, in step S81, a gap length is adjusted with the slide amount=0 to obtain a coupling coefficient m at which desired power can be obtained. Next, in step S82, the slide amount n at which the coupling coefficient m obtained by changing the slide amount while being fixed to a desired gap length is obtained is obtained. Then, in step S83, a mechanism of the power transmission device and the power reception device is designed so that the slide amount of the center of the power transmission coil and the center of the power reception coil becomes n.

In this way, according to the present embodiment, it is possible to provide a power transmission device and a power reception device having relative positions of a power transmission coil and a power reception coil allowing maximization of transmissible power, and a power transmission/reception system including the same.

### Second Embodiment

In the first embodiment, it is possible to provide a power transmission device and a power reception device having relative positions of a power transmission coil and a power reception coil allowing maximization of transmissible power. However, since the relative positions of the power transmission coil and the power reception coil allowing maximization of transmissible power change for each shape, size, and gap length of the power transmission coil and the power reception coil, it is necessary to produce and manufacture each of products corresponding to different relative positions, and there is a problem that each product has a different manufacturing number and it is necessary to obtain product certification for each product. Therefore, in the present embodiment, a description will be given of a configuration that has a configuration adjustable to different relative positions and can handle different relative positions with one product.

FIG. 10 is a schematic configuration block diagram of a power transmission/reception system in the present embodiment. In FIG. 10, the same configurations as those in FIG. 1 are designated by the same reference symbols, and a description thereof will be omitted. FIG. 10 is different from FIG. 1 in that the power transmission device 10 is provided with a mechanism capable of moving the power transmission coil. That is, a difference is that the power transmission coil 16 is installed on a base 18 that can move along rails 19a and 19b, and a knob 18a that can adjust a position of the base 18 from the outside is provided. Note that the mechanism is not limited to the rails, and any mechanism may be used as long as the power transmission coil 16 and the base 18 can be moved in parallel. The movement may be in either the x-direction or the y-direction, or both may be combined.

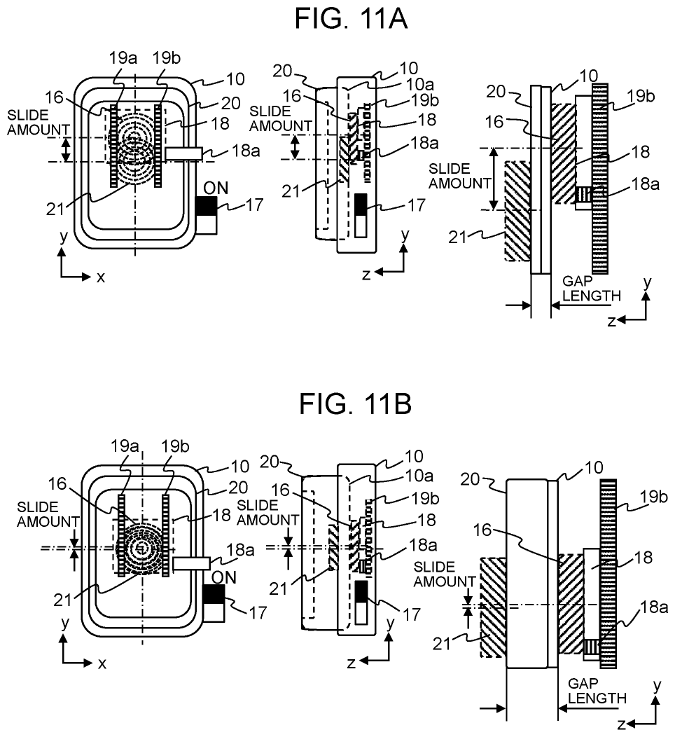

FIGS. 11A and 11B are plan views and side views of a state in which the power reception device 20 is placed on the power transmission device 10 in the present embodiment. In FIGS. 11A and 11B, the same configurations as those in FIG. 5 are designated by the same reference symbols, and a description thereof will be omitted. FIGS. 11A and 11B are different from FIG. 5 in that the power transmission coil 16 is installed on a base 18 that can move along rails 19a and 19b, and a knob 18a that can adjust a position of the base 18 from the outside is provided.

In FIG. 11A, a gap length between the power transmission coil and the power reception coil is a first length, whereas in FIG. 11B, the power reception device 20 is enlarged and the gap length is longer than the first length. Note that, in FIGS. 11A and 11B, the left side is a plan view, the center is a side view, and the right side is an enlarged view of the center which is the side view, respectively.

As illustrated in the right side of FIG. 11A, when the gap length is the first length, the knob 18a is slid to adjust the position of the power transmission coil 16 to a predetermined position allowing maximization of transmissible power. On the other hand, as illustrated in the right side of FIG. 11B, when the gap length is longer than the first length, the relative distance between the power transmission coil and the power reception coil allowing maximization of transmissible power becomes smaller than that in the case of the right side of FIG. 11A. Thus, the position of the power transmission coil 16 is adjusted to a desired position by sliding the knob 18a so that the slide amount, which is the relative distance, becomes smaller than that of the right side of FIG. 11A.

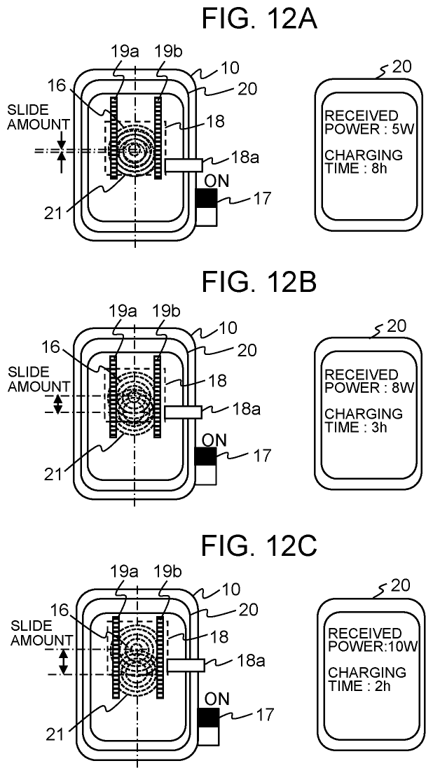

FIGS. 12A to 12C are diagrams for description of an example of a display screen in the power reception device 20 in the present embodiment. When a battery capacity is set to Q [wh], received power is set to P [w], and a charging time is set to h [h] in the power reception device 20, a relationship thereof is Q=P*h. Therefore, when the battery capacity and the received power are determined, the charging time can be calculated. Therefore, the slide amount, which is the relative distance between the power transmission coil and the power reception coil, can be adjusted by the knob 18a. Thus, the charge control unit 23 can perform setting to an adjusted state desired by the user by calculating the charging time from the received power in an adjusted state and displaying the charging time.

Each of FIGS. 12A to 12C illustrates a plan view in a state in which the power reception device 20 is placed on the power transmission device 10 when the slide amount is different and a display screen of the power reception device 20. In FIG. 12A, the slide amount is small, and for example, the display screen of the power reception device 20 displays that the received power is 5 W and the charging time is 8 hours. In FIG. 12B, when the knob 18a is used to adjust the slide amount in an increasing direction comparing to FIG. 12A, the display screen of the power reception device 20 displays that the received power is 8 W and the charging time is 3 hours. Further, in FIG. 12C, when the knob 18a is used to adjust the slide amount in a further increasing direction comparing to FIG. 12B, the display screen of the power reception device 20 displays that the received power is 10 W and the charging time is 2 h. Therefore, the user can adjust the slide amount using the knob 18a so that the desired charging time is obtained while looking at the display screen.

As described above, in the present embodiment, since the mechanism capable of adjusting the slide amount, which is the relative distance between the power transmission coil and the power reception coil, is provided, it is possible to correspond to different relative positions allowing maximization of transmissible power by one product, and there is an effect of eliminating the need to individually certify products. In addition, the user can adjust the slide amount so that the desired charging time is obtained while looking at the display screen.

### Third Embodiment

In the first embodiment, the position of the power transmission coil is changed so as to be the relative distance between the power transmission coil and the power reception coil allowing maximization of transmissible power. On the other hand, in the present embodiment, a description will be given of an example in which the relative distance between the power transmission coil and the power reception coil is changed without changing the position of the power transmission coil.

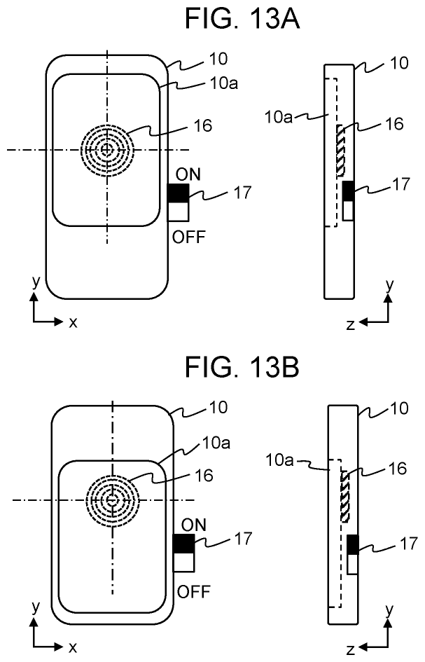

FIGS. 13A and 13B are plan views and side views of the power transmission device 10 in the present embodiment. In FIGS. 13A and 13B, the same configurations as those in FIG. 3 are designated by the same reference symbols, and a description thereof will be omitted. FIGS. 13A and 13B are different from FIG. 3 in that a position of the recess 10a on which the power reception device 20 is placed is changed.

In FIGS. 13A and 13B, while the position of the recess 10a is disposed in the upper part of the power transmission device 10 in the y-axis direction in FIG. 13A, the position of the recess 10a is disposed in the lower part of the power transmission device 10 in the y-axis direction in FIG. 13B. Since the recess 10a matches the outer shape of the power reception device 20 and serves as a recess for positioning the power reception device 20, the relative distance between the power transmission coil and the power reception coil can be changed by changing the position of the recess 10a in the power transmission device 10 as illustrated in FIGS. 13A and 13B.

Note that the position of the recess 10a may be movable, or a plurality of face plates having different positions of the recess 10a may be bundled and replaced by the user according to the model of the power reception device 20.

As described above, according to the present embodiment, it is possible to provide a power transmission device and a power reception device having relative positions between a power transmission coil and a power reception coil allowing maximization of transmissible power without changing the position of the power transmission coil, and a power transmission/reception system including the same.

### Fourth Embodiment

In the present embodiment, a description will be given of an example in which a data transmission function is provided between the power transmission device and the power reception device.

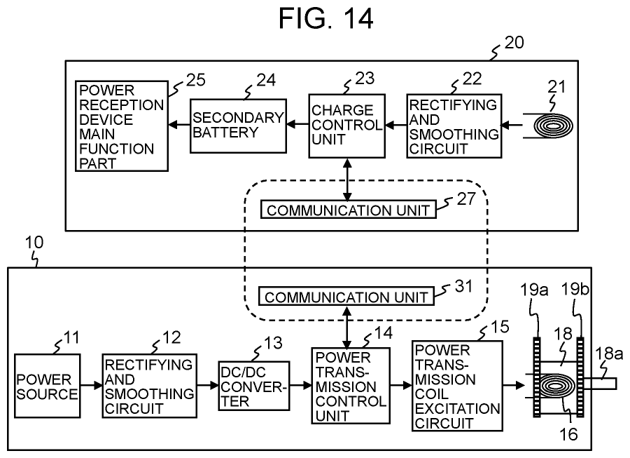

FIG. 14 is a schematic configuration block diagram of a power transmission/reception system in the present embodiment. In FIG. 14, the same configurations as those in FIG. 10 are designated by the same reference symbols, and a description thereof will be omitted. FIG. 14 is different from FIG. 10 in that communication units 31 and 27 are provided in the power transmission device 10 and the power reception device 20, respectively, and the power transmission SW is eliminated. That is, the communication units 31 and 27 transmit data between the power transmission device 10 and the power reception device 20. Note that when the power reception device main function part 25 has a communication unit, the communication unit 27 of the power reception device 20 may also be used as the communication unit. Further, data transmission performed by the communication units 31 and 27 may be performed using a coil for power transmission.

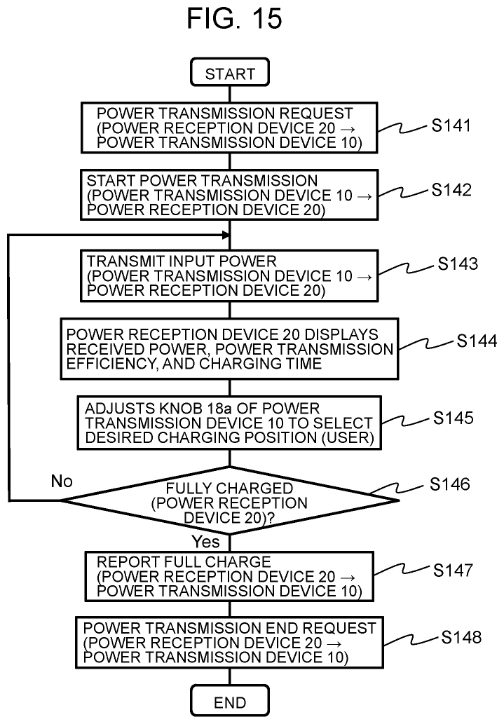

FIG. 15 is a processing flow diagram of wireless power transmission using data transmission in the present embodiment. In FIG. 15, first, in step S141, a power transmission request is transmitted from the power reception device 20 to the power transmission device 10 via the communication units 27 and 31. In response thereto, in step S142, the power transmission device 10 starts power transmission to the power reception device 20. As described above, in the present embodiment, manual switching of the power transmission SW in the first embodiment is not required by performing data transmission.

Then, in step S143, the power transmission device 10 transmits data of input power to the power reception device 20 via the communication units 31 and 27. In step S144, the power reception device 20 calculates power transmission efficiency=received power/input power*100(%) from the received power supplied to the secondary battery 24 and the received input power of the power transmission device 10, calculates the charging time from the battery capacity and the received power, and displays the received power, the power transmission efficiency, and the charging time.

In step S145, the user adjusts the knob 18a of the power transmission device 10 to select a desired charging position. Then, in step S146, the power reception device 20 determines whether charging is fully performed by the charge control unit 23, and when charging is not fully performed, the operation returns to step S143 to continue charging. In addition, when charging is fully performed, the operation proceeds to step S147, and the power reception device 20 notifies the power transmission device 10 that charging is fully performed via the communication units 27 and 31. Then, in step S148, the power reception device 20 transmits a power transmission end request to the power transmission device 10 via the communication units 27 and 31. Note that either step S147 or S148 may be omitted, and the notification of full charge may be regarded as a power transmission end request.

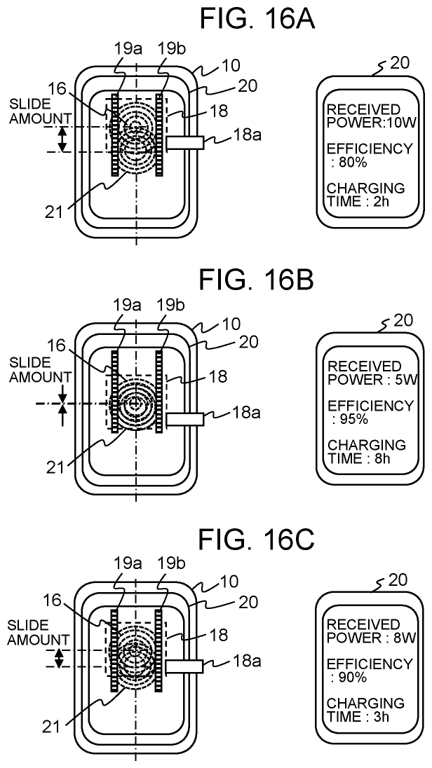

FIGS. 16A to 16C are diagrams for description of an example of a display screen in the power reception device 20 in the present embodiment. In FIGS. 16A to 16C, the same configurations as those in FIGS. 12A to 12C are designated by the same reference symbols, and a description thereof will be omitted. FIGS. 16A to 16C are different from FIGS. 12A to 12C in that the power transmission efficiency is additionally displayed on the display screen. That is, since information about the input power of the power transmission device 10 is required to calculate the power transmission efficiency, calculation and display are performed by the power reception device 20 using the information about the input power transmitted from the power transmission device 10 to the power reception device 20 via the communication units 31 and 27.

Each of FIGS. 16A to 16C illustrates a plan view of a state in which the power reception device 20 is placed on the power transmission device 10 when the slide amount is large, small, and medium, respectively, and a display screen of the power reception device 20.

FIG. 16A is an example of a case where the slide amount is adjusted in an increasing direction by the knob 18a and the position of the power transmission coil is adjusted to obtain the relative distance between the power transmission coil and the power reception coil allowing maximization of transmissible power, a case where a transmittable power priority is selected as a power transmission mode, and a case where fastest charging can be performed. The display screen of the power reception device 20 displays that the received power is 10 W, the efficiency is 80%, and the charging time is 2 hours. FIG. 16B is an example of a case where the slide amount is adjusted in a decreasing direction by the knob 18a and a power transmission efficiency priority is selected as a power transmission mode and a case where the power transmission efficiency is the highest. For example, the display screen of the power reception device 20 displays that the received power is 5 W, the efficiency is 95%, and the charging time is 8 hours. FIG. 16C is an example of a case where the slide amount is adjusted by the knob 18a to be larger than that of FIG. 16B and to be smaller than that of FIG. 16A and a case where a state in which charging is completed within a permissible time and the power transmission efficiency is not so poor is selected in consideration of the charging time and the power transmission efficiency (intelligent mode). For example, the display screen of the power reception device 20 displays that the received power is 8 W, the efficiency is 90%, and the charging time is 3 hours.

As described above, according to the present embodiment, the user can adjust the slide amount using the knob 18a so as to obtain the desired power transmission mode while checking the received power, the power transmission efficiency, and the charging time of the display screen.

Even though the embodiments have been described above, the invention is not limited to the above-mentioned embodiments, and various modifications are included. For example, the embodiments have been described in detail in order to describe the invention in an easy-to-understand manner, and are not necessarily limited to those having all the described configurations. Further, it is possible to replace a part of a configuration of one embodiment with a configuration of another embodiment, and it is possible to add a configuration of one embodiment to a configuration of another embodiment. Further, with respect to a part of a configuration of each embodiment, it is possible to add/delete/replace another configuration.

What is claimed is:

1. A power transmission device that has a power transmission coil and transmits power to a power reception device having a power reception coil by wireless power transmission, the power transmission device comprising
positioning means for placing the power reception device, the power transmission coil being disposed to be substantially parallel to a lower part of a placement surface of the positioning means,
wherein when the power reception device is placed on the placement surface of the positioning means, the power reception coil is disposed to be substantially parallel to the placement surface and is disposed by sliding a center of the power transmission coil by a predetermined distance from a center of the power reception coil.

2. The power transmission device according to claim 1, wherein the positioning means is a recess having a flat surface, and a shape of the recess matches an outer shape of the power reception device.

3. The power transmission device according to claim 1,
wherein a power transmission coil storage space having a plurality of positions where the power transmission coil is allowed to be installed is provided by being disposed to be substantially parallel to a lower part of the placement surface of the positioning means, and
a relative distance between a center of the power transmission coil and a center of the power reception coil is selectable when the power reception device is placed on the placement surface of the positioning means.

4. The power transmission device according to claim 1,
wherein when the power reception device is placed on the placement surface of the positioning means, the power transmission coil and the power reception coil are disposed with a predetermined gap length via the placement surface, and
the gap length is adjusted while a slide amount of a center of the power transmission coil and a center of the power reception coil is 0 to obtain a coupling coefficient m within a range in which target power p is obtained from a characteristic indicating a relationship between the coupling coefficient and transmissible power, and the slide amount is obtained as a slide amount at which the coupling coefficient becomes the obtained m under a condition of the predetermined gap length from a characteristic indicating a relationship between the coupling coefficient and the transmissible power.

5. The power transmission device according to claim 1,
wherein a mechanism capable of moving the power transmission coil is provided, and
a distance between a center of the power transmission coil and a center of the power reception coil is adjustable.

6. The power transmission device according to claim 5, wherein the mechanism capable of moving has a configuration in which the power transmission coil is installed on a base movable along rails and a knob capable of adjusting a position of the base from an outside is provided.

7. The power transmission device according to claim 1,
wherein a plurality of configurations in which positions of the positioning means for placing the power reception device are different is provided, and
when the power reception device is placed on the placement surface of the positioning means, a relative distance between a center of the power transmission coil and a center of the power reception coil is selectable by changing a position of the positioning means.

8. The power transmission device according to claim 7, wherein the plurality of configurations in which the positions of the positioning means are different is configurations capable of moving the positions of the positioning means.

9. The power transmission device according to claim 7, wherein the positioning means is a recess having a flat surface, and the plurality of configurations in which the positions of the positioning means are different is a plurality of face plates having different positions of the recess.

10. The power transmission device according to claim 1, further comprising:
a communication unit that receives data from the power reception device; and
a power transmission control unit,
wherein the power transmission control unit starts power transmission to the power reception device in response to a power transmission request transmitted from the power reception device via the communication unit, and stops power transmission to the power reception device in response to a full charge notification or a power transmission end request transmitted from the power reception device via the communication unit.

11. A power reception device that has a power reception coil and receives power transmission by wireless power transmission from a power transmission device having a power transmission coil, the power reception device comprising:
a secondary battery charged by power transmitted by the power transmission;
a display unit; and
a charge control unit,
wherein the charge control unit calculates a charging time of the secondary battery from receive power which is power transmitted by the power transmission and a battery capacity of the secondary battery, and displays the received power and the charging time on the display unit.

12. The power reception device according to claim 11, further comprising
a communication unit that receives data from the power transmission device,
wherein the charge control unit uses information about input power transmitted from the power transmission device via the communication unit to calculate a power transmission efficiency from a ratio of the received power to the input power, and displays the calculated power transmission efficiency on the display unit.

13. A power transmission/reception system that performs power transmission by wireless power transmission from a power transmission device having a power transmission coil to a power reception device having a power reception coil,
wherein the power transmission device has positioning means for placing the power reception device, and the power transmission coil is disposed to be substantially parallel to a lower part of a placement surface of the positioning means,
the power reception device is configured so that a lower surface of a housing is placed to face the placement surface of the positioning means when power transmission is performed, and the power reception coil is disposed to be substantially parallel to the lower surface of the housing, and
when the power reception device is placed on the placement surface of the positioning means of the power transmission device, the power reception device is disposed by sliding a center of the power transmission coil by a predetermined distance from a center of the power reception coil.

14. The power transmission/reception system according to claim 13,
wherein the power transmission device is provided with a mechanism capable of moving the power transmission coil, and
a distance between a center of the power transmission coil and a center of the power reception coil is adjustable.

15. The power transmission/reception system according to claim 13,
wherein the power transmission device includes
a power transmission device communication unit that receives data from the power reception device, and
a power transmission control unit,
the power transmission control unit starts power transmission to the power reception device in response to a power transmission request transmitted from the power reception device via the power transmission device communication unit and stops power transmission to the power reception device in response to a full charge notification or a power transmission end request transmitted from the power reception device via the power transmission device communication unit,
the power reception device includes
a secondary battery charged by power transmitted by the power transmission,
a power reception device communication unit that receives data from the power transmission device,
a display unit, and
a charge control unit, and
the charge control unit calculates a charging time of the secondary battery from receive power which is power transmitted by the power transmission and a battery capacity of the secondary battery, calculates a power transmission efficiency from a ratio of the received power to the input power using information about input power transmitted from the power transmission device via the power reception device communication unit, and displays the received power, the charging time, and the power transmission efficiency on the display unit.
